(19) United States
(12) Patent Application Publication
(10) Pub. No.: US 2025/0105312 A1
(43) Pub. Date: Mar. 27, 2025

(54) ALIGNMENT DEVICE FOR AN ELECTRIC CELL STACK, PARTICULARLY A FUEL CELL STACK

(71) Applicants: Stefan MUNTHE, Västra Frölunda (SE); Johan FLINK, Göteborg (SE); Robin VELÉN, Hovas (SE); POWERCELL SWEDEN AB, Göteborg (SE)

(72) Inventors: Stefan MUNTHE, Västra Frölunda (SE); Johan FLINK, Göteborg (SE); Robin VELÉN, Hovas (SE)

(21) Appl. No.: 18/832,846

(22) PCT Filed: Feb. 6, 2023
(86) PCT No.: PCT/SE2023/050094

§ 371 Date: Jul. 24, 2024

(30) Foreign Application Priority Data
Feb. 10, 2022 (SE) 2250133-2

(51) Int. Cl. H01M 8/0256; H01M 8/1004; H01M 8/2465

(52) U.S. Cl. CPC H01M 8/0256; H01M 8/1004; H01M 8/2465

(57) ABSTRACT

Disclosed is an electric cell stack comprising at least a plurality of electric plates and a plurality of insulating layers, wherein the stack of the plurality of electric plates and insulating layers are alternatingly stacked in such a way that the electric plates are separated by insulating layers, and the electric plates and/or the insulating layers are aligned to each other, wherein each electric plate has a first alignment through hole and a second alignment through hole, wherein at and/or in the alignment through holes inner alignment elements are provided for aligning the electric plates and the insulating layers, wherein each inner alignment element has a base plate and an adjusting portion protruding from the base plate, wherein the adjusting portion of one alignment element extends through at least a first electric plate, a first insulating layer, a second electric plate and a second insulating layer.

The present invention relates to an electric cell stack according to claim 1 and in particular to a fuel cell stack.

Usually, an electric cell stack comprises a plurality of stacked electric plates which are separated from each other by insulating layers.

In the special case of a fuel cell stack, the electric plates are bipolar plates and the insulating layers are multi-layer membrane electrode assemblies. The bipolar plates themselves are a combination of an anode plate and a cathode plate which are fixed to each other, wherein the bipolar plates are then separated, or with other words sandwiched, by the membrane electrode assemblies. The cathode and anodes plate which form the bipolar plates are usually electrically conducting metal or graphite plates, so called flow field plates, having a flow field for the reactants at one side and a flow field for a cooling fluid on the other side. In the assembled state of the membrane electrode assembly the flow field plates are placed on top of each other in such a way that the cooling fluid flow fields are facing each other and the reactant fluid flow fields face the sandwiching membrane electrode assemblies. The electric current produced by the membrane electrode assemblies during operation of the fuel cell stack results in a voltage potential difference between the bipolar plate assemblies.

In order to form the electric cell stack, all the electric plates and insulating layers, e.g. the membrane electrode assemblies and the bipolar plates, are alternatingly stacked onto each other. However, the alignment of each electric plate to the associated insulating layer, e.g. the membrane electrode assembly, as well as the alignment between the electric plates themselves is crucial for the performance of the finished electric cell stack.

The desired alignment is usually achieved with the aid of alignment features such as alignment rods or an alignment rack, which interact with alignment structures provided at the electric plates. However, after aligning the stack, the stack has to be removed from the alignment feature, with the risk that the alignment of the electric plates and the insulating layers is lost.

It is therefore object of the present invention to provide an electric cell stack in general, and especially a fuel cell stack, which allows for a more efficient stacking and a more reliable alignment of the stacked components without the risk of loosing the alignment, when the stack is removed from the alignment feature.

This object is solved by an electric cell stack according to claim 1.

In the following, an electric cell stack, and in particular a fuel cell stack, is proposed, wherein the electric stack comprises at least a plurality of electric plates and a plurality of insulating layers. Thereby, the plurality of electric plates and insulating layers are stacked in such a way that the electric plates are separated by insulating layers, and the electric plates and/or the insulating layers are aligned to each other.

In general, in this application, the term “electric plate” does not necessarily refer to a rigid electric plate. Also, a flexible layer-like electric element (anode or cathode) may be named as electric plate in this application.

However, in case the electric cell stack is a fuel cell stack, the electric plate is a bipolar plate, wherein each bipolar plate consists of an anode plate and a cathode plate, which are fixed to each other. Further in that case, the insulating layers are multilayer membrane electrode assemblies. The bipolar plates are usually rigid metal or graphite plates which are provided with flow field structures for providing and distributing reactant and/or coolant to the bipolar plate and/or to the adjacent membrane electrode assemblies.

In order to reliably and automatically align the plurality of electric plates to each other, each electric plate has a first alignment through hole and a second alignment through hole, wherein at and/or in the alignment through holes inner alignment elements are provided for aligning the electric plates and the insulating layers. These inner alignment elements ensure that even when an external stacking or alignment device, such as an alignment rod or alignment rack is removed, the stacked components remain in the stacked and aligned position.

Thereby, the first and second alignment through holes may preferably be diagonally or diametrically spaced from each other in relation to the electric plate.

It should be noted that also the insulating layers may be provided with corresponding alignment through holes, and may likewise cooperate with the alignment elements. It should be further noted that the alignment element could also be an integral part of the insulating layer. In case of fuel cells, the insulating layer is a membrane electrode assembly and then the alignment element is preferably an integral element of a subgasket of the membrane electrode assembly.

Further, each inner alignment element has a base plate and an adjusting portion protruding from the base plate, wherein the adjusting portion of one alignment element extends through at least a first electric plate, a first insulating layer, a second electric plate and a second insulating layer. In case the alignment element is an integral part of the insulating layer, the base plate may be flush with the insulating layer.

Since the inner alignment element extends through at least two unit cells (each unit cell comprising one electric plate and one insulating layer) it can be ensured that, the adjacent electric plates are aligned to each other. As also mentioned above, the inner alignment feature allows for a permanent alignment during the life time of the electric cell and not only during the stacking period.

According to a further preferred embodiment, the adjusting portion of the alignment element is recessed form the base plate, so that a step is formed between the base plate and the adjusting portion. This allows for a simple mounting of the alignment element to the electric plate. Alternatively, it is also possible to mount the alignment element by other fixation methods, e.g. by clicking the alignment element into the electric plate or by soldering/welding the alignment element to the electric plate or by integrating the alignment element between anode and cathode plate of a bipolar plate.

For increasing the precision and accuracy of the alignment, it is further preferred if, at the opposite side of the adjusting portion, the base plate of the alignment element has a recess which is dimensioned to accommodate the adjusting portion of an adjacent second alignment element, so that a first alignment element is adapted to be stacked on a second alignment element. The cooperation between recess in the base plate of one alignment element and the adjusting portion of the adjacent alignment element allows for the formation of an internal alignment rod, which fixes the orientation of the stack components to each other. It further allows for a space efficient stacking of the alignment elements since the alignment elements can be stack on top of each other.

Thereby, it is particularly preferred, if the alignment elements are arranged in such a way that for each single electric plate one of the alignment through holes is in contact with the base plate of a first alignment element, wherein the other alignment through hole of the very same electric plate is only in contact with the adjusting portion of another second alignment element. Thereby, the alignment elements are alternatingly arranged and extend through second electric plates which have been oriented by preceding alignment elements. That means, e.g. at electric plate 1, the base plate of a first alignment element 1 is arranged and its adjusting portion extends through electric plate 2, at electric plate 2, the base plate of a second alignment element is arranged and its adjusting portion extends through electric plate 3, at electric plate 3, the base plate of a third alignment element is arranged and its adjusting portion extends through electric plate 4, and so on. Thus, all electric plates are interconnected by the alignment elements which increases the stacking and alignment accuracy.

For simplifying the above described alternating arrangement of alignment elements at/in the alignment through holes, it is further preferred that the first alignment through hole has a first shape, and the second alignment through hole has a second shape, wherein the first and second shape are different. Thereby, it particularly preferred, if one of the alignment through holes has an elongated shape, whereas the second alignment through hole has a circular shape. Additionally or alternatively, the first alignment through hole is arranged at a different location than the second alignment through hole. This allows for a reliable and automatic alignment of the electric plates and insulating layers.

It is further preferred if, the shape of the base plate of the inner alignment element and/or the shape of the adjusting portion of the alignment elements are adapted to the shape/size of the alignment through holes of the electric plates. This allows for a fail-safe stacking and alignment of the components and increases the stacking and alignment accuracy.

Thereby it is also preferred, if the size and shape of the alignment through holes is slightly larger than the size and shape of the alignment element so that there is a loose fit between the alignment elements and the alignment through holes during the stacking, which results in a pre-alignment of the components. The final alignment is then achieved by the subsequent pressing of the stack during which the alignment elements may be deformed into the remaining space of the alignment through holes so that after having compressed the stack, the inner alignment elements fit snuggly into the alignments holes and provide the lifetime long alignment of the stack.

According to a further preferred embodiment, adjacent electric plates and corresponding first and second alignment through holes are arranged in such a way that the first alignment through hole of one electric plate is aligned with the second alignment through hole of the adjacent electric plate. Thereby, it is preferred, if the electric plates are symmetric concerning a rotation of 180° around the surface normal of the electric plate. In case the electric plate is a bipolar plate it is preferred that the bipolar plates are symmetrical concerning a rotation of 180° around the surface normal of the cathode or anode side. Thereby, rotation of each second electric plates of the stack by 180° results in an automatic arrangement of alternating first and second alignment through holes. Besides a simplified manufacturing, stacking and alignment, as only one set of electric plates has to be produced, this allows also for compensating manufacturing tolerances, which would lead to an uneven size of the stack.

As mentioned above, the at least one insulating layer may also comprise alignment through holes which are configured to cooperate with at least one alignment element. Preferably, the insulating layer may have two alignment through holes that are arranged in correspondence to the first and second alignment through holes of the electric plate. However, it is also possible that the alignment through hole of the insulating layer differ from the first and second alignment through of the electric plate in size and/or shape.

As mentioned above, each alignment element extends through at least a first electric plate, a first insulating layer, a second electric plate and a second insulating layer. Consequently, an overall height ha of the alignment element is adapted to be equal to or greater than two cell pitches (one cell pitch being the combined height of electric plate and insulating layer): H≥2*(D_{EP}+D_{IL}). For a fuel cell stack this relation would read: H≥2*(D_{BBP}+D_{MEA}). In other words, the alignment element is preferably higher than two cell pitches such that the top of the alignment element extends over the second unit cell.

According to a further preferred embodiment, the adjusting portion of each alignment element has a first adjusting part and a second adjusting part, wherein a size and/or shape of the first adjusting part is adapted to the shape of the first alignment through hole and/or a size and/or shape of the second adjusting part is adapted to the shape of the second alignment through hole. This also allows for a fail-safe alignment and stacking of the components.

Thereby it is particularly advantageous if the second adjusting part of the adjusting portion or the alignment element is recessed from the first adjusting part, thereby forming a step between the first and the second adjusting part of the alignment element, wherein preferably the size of the first adjusting part is adapted to the size and/or shape of the first alignment through hole and the size of the second adjusting part is adapted to the size and/or shape of the second alignment through hole. This allows for alignment through holes of different size and shape which increases the stacking accuracy.

According to a further preferred embodiment, a height hₐ₁ of the first adjusting part is designed to resemble one cell pitch, namely the thickness DEP of the electric plate plus the thickness D_{IL} of the insulating layer hₐ₁˜D_{EP}+D_{IL}, whereas a height hₐ₂ of the second adjusting part is designed to be equal to/greater than one cell pitch, so that hₐ₂≥D_{EP}+D_{IL}. For a fuel cell this relation would read hₐ₂≥D_{BBP}+D_{MEA}.

Furthermore, a shape and depth of the recess hᵣ in the base plate and a shape and the height hₐ₂ of the second adjusting part may be designed so that the excess portion of the adjusting portion which exceeds the height of one cell pitch, is adapted to the depth hᵣ of the recess: hₐ₂˜D_{EP}+D_{IL}+hᵣ. For a fuel cell this relation would read: hₐ₂=D_{BPP}+D_{MEA}+hᵣ. This may allow to stack the alignment elements on top of each other.

It should be noted that for the above identified relations, the compression of he finalized stack should be taken into account.

Besides only connecting two adjacent electric plates and their corresponding insulating layers, it is also possible that the adjusting portion of the alignment element is adapted to be greater than a multiple (more than 2) of the cell pitch, so that the alignment element is adapted to align a plurality of unit cells. This has the further advantage that the number of alignment elements can be reduced since each alignment element can align a plurality of unit cells. Also, the number of required alignment elements can be reduced.

According to a further preferred embodiment, the electric plate further comprises a flow field for distributing reactant over the electric plate. Thereby, the flow field may be designed as protruding structure protruding from a basis of the plate. Alternatively, the plate may also have other protruding structures, e.g. a bead seal, which also protrudes from the basis of the electric plate. These protruding structures are common for fuel cells, where the bipolar plates are designed to distribute reactant to the membrane electrode assembly.

In case the electric plate has at least one protruding structure, e.g. a bead seal or flow field, which protrudes from the basis of the electric plate in direction of the adjacent insulating layer it is further preferred that a height h_{b} of the base plate of the alignment element is designed to resemble, preferably to be less than, a protruding height D_{PS} of the protruding structure over the basis of the electric plate: h_{b}˜D_{PS}, preferably h_{b}<D_{PS}.

According to a further preferred embodiment and in case the electric plates has at least one protruding structure, not only the height of base plates of the alignment element may resemble the height of the protruding structure but also the first aligning part of the aligning portion hₐ₁<D_{PS}. This embodiment allows for insulating layer which have alignment through holes which are equal shaped and adapted to the size and shape of the second adjusting part of the adjusting portion. This allows for freely placeable insulating layers.

According to a further preferred embodiment, due to the voltage potential difference between the electric plates, it is preferred if the alignment element is made of an electrically isolating material, for example a plastic material. It is further advantageous that the alignment element is molded, preferably injection molded.

Further preferred embodiments are defined in the dependent claims as well as in the description and the figures. Thereby, elements described or shown in combination with other elements may be present alone or in combination with other elements without departing from the scope of protection.

In the following, preferred embodiments of the invention are described in relation to the drawings, wherein the drawings are exemplarily only, and are not intended to limit the scope of protection. The scope of protection is defined by the accompanied claims, only.

The figures show:

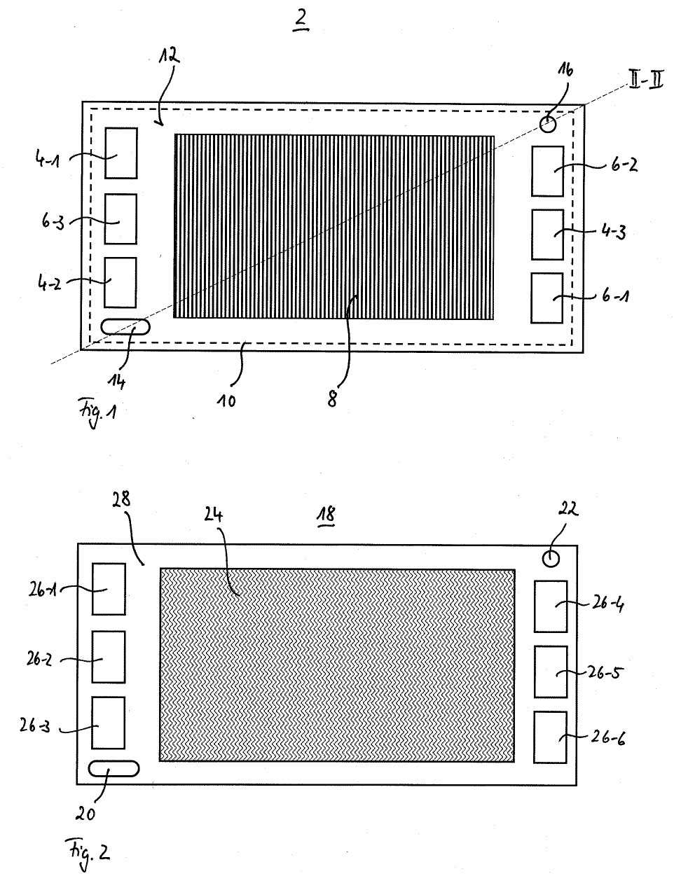

FIG. 1: a schematic top view of a bipolar plate of fuel cell stack according to a first embodiment,

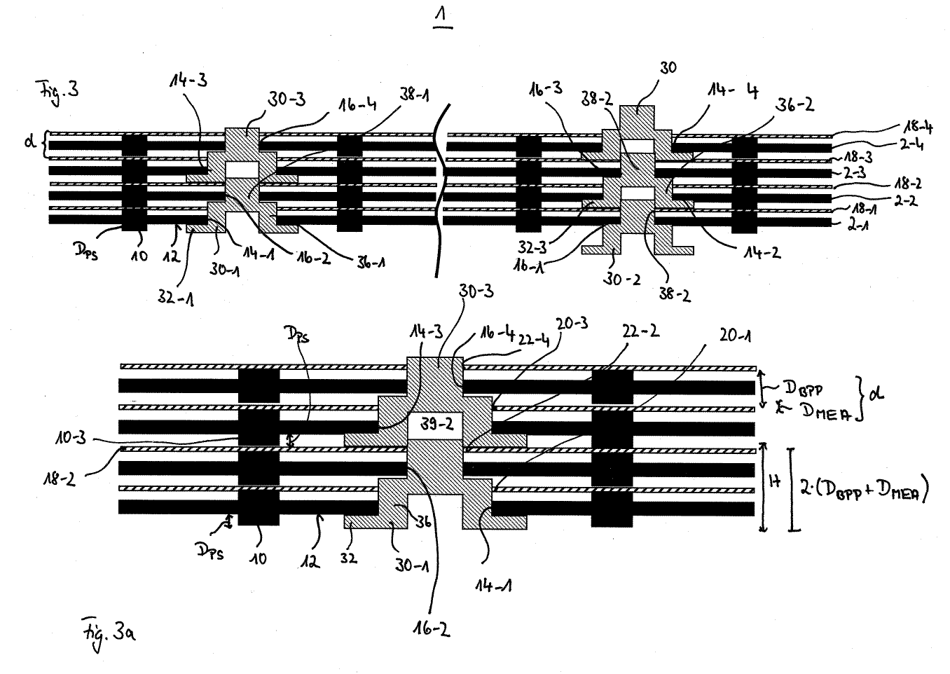

FIG. 2: a schematic top view of a membrane electrode assembly of fuel cell stack according to a first embodiment,

FIG. 3: a schematic cross section through a part of a fuel cell stack according to a first embodiment,

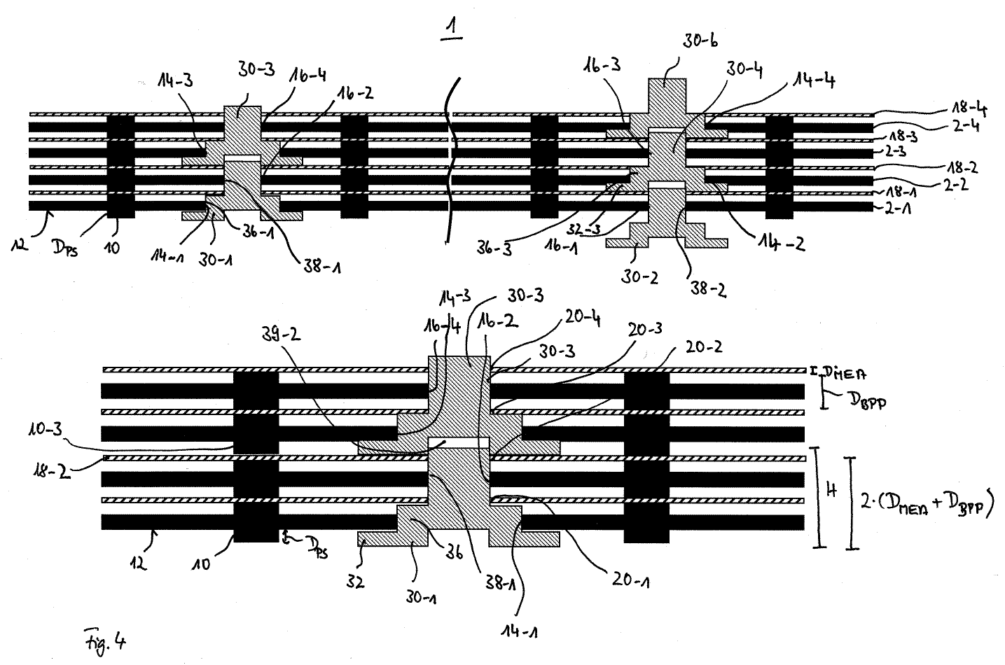

FIG. 4: a schematic cross section through a part of a fuel cell stack according to a second embodiment,

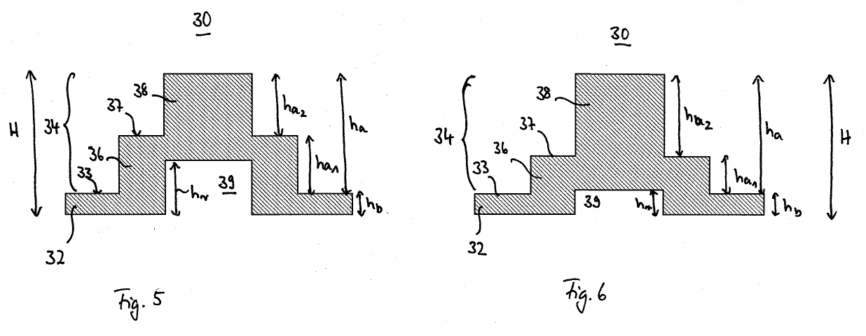

FIG. 5: a schematic enlarged cross section view through alignment elements as illustrated in FIG. 3, and

FIG. 6: a schematic enlarged cross section view through alignment elements as illustrated in FIG. 4.

In the following same or similar functioning elements are indicated with the same reference numerals.

In the following the principle of the invention is described for the case of a fuel cell stack. However, the principle can be likewise applied to any other kind of electric cell or electric cell stack.

FIG. 1 shows a simplified schematic top view of a bipolar plate 2 (electric plate) of a fuel cell stack 1 according to a first embodiment. Usually, each bipolar plate 2 is a combination of an anode plate and a cathode plate which are fixed to each other. Each anode and cathode plate has a front side and a back side, wherein the front or reactant side faces an adjacent membrane electrode assembly (not shown in FIG. 1) and the back or coolant sides faces each other. Further each bipolar plate 2 has a plurality of openings 4, 6, namely manifolds, for providing (openings 4) and discharging (openings 6) reactant and coolant to and from the bipolar plate 2. For distributing the reactant and coolant over the plate the bipolar plates may further have protruding structures (not shown) which form fluid flow fields 8 for the respective reactant/coolant. For sealing the flow fields to the environment, the plates are further equipped with so called bead seals 10 which protrude from a basis 12 of the plate and may also extend over the height of the flow field structures.

Furthermore, the bipolar plate 2 has a first alignment through hole 14 and a second alignment through hole 16, wherein the first alignment through hole 14 is arranged at a different location than the second alignment through hole 16. In FIG. 1, the first alignment through hole 14 is diametrically opposite arranged to the second alignment through hole 16. Thereby, the first and second alignment through holes 14, 16 are symmetric concerning a rotation of 180° around a surface normal of the bipolar plate.

As further illustrated in FIG. 1, the first alignment through hole 14 has an elongated shape, whereas the second alignment through hole 16 has a circular shape. Thus, both alignment through holes differ in shape and size. However, it would be also possible that the first and the second alignment through holes 14; 16 have both elongated shapes, wherein a longitudinal axis of the first alignment through hole 14 is may be perpendicular to the longitudinal axis of the second alignment through hole 16.

FIG. 2 illustrates a membrane electrode assembly 18, which may be used in combination with the bipolar plate of FIG. 1 in a fuel cell stack. As can be seen in FIG. 2, also the membrane electrode assembly 18 is equipped with alignment through holes 20, 22 which allows for an alignment of the membrane electrode assembly 18 with bipolar plate 2. As can be seen form a comparison of FIG. 1 and FIG. 2, the membrane electrode assembly 18 may have the same or a similar shape as the bipolar plate 2, and has an active region 24 which is in the same area as the flow field region of the bipolar plate 2. The active region 24 of the membrane electrode assembly 18, is usually the 3-layered electrode membrane assembly consisting of the membrane which is sandwiched between an anode and a cathode. The other structures, such as manifold openings 26 or alignment through holes 20, 22 are preferably provided in a subgasket material 28, which surrounds and carries the active region 24 of the 3-layer membrane electrode assembly, and electrically isolates the sandwiching bipolar plates. Additionally, the membrane electrode assembly may further comprise, on both sides gas, diffusion layers (not illustrated), which are also arranged in the active region 24 and cover the anode and cathode of the 3-layer membrane electrode assembly 18.

FIGS. 3 and 4 and their enlarged view 3a and 4a, how each a schematic cross section along a line II-II of FIG. 1 through the alignment through holes 14; 16 of two embodiments for a fuel cell stack 1 comprising a plurality of bipolar plates 2-1, 2-2, 2-3, 2-4 with interlaying membrane electrode assemblies 18-1, 18-2, 18-2, 18-4. For the sake of simplicity, in the cross-section views of FIGS. 3, as well as of FIG. 4, the bipolar plates 2 are schematically illustrated as single plates with protruding structures 10, which protrude over a basis 12 by the height D_{PS}.

Additionally, the embodiments of the fuel cell stack 1 illustrated in FIGS. 3 and 4 show a special stacking order for the bipolar plate and membrane electrode assemblies. In that, every second bipolar plate 2-2, 2-4 . . . is rotated by 180° compared to bipolar plates 2-1, 2-3 . . . , so that the first alignment through holes 14-1, 14-3 . . . of the first bipolar plates 2-1, 2-3 . . . are aligned with the second alignment through hole 16-2, 16-4 . . . of the second bipolar plates 2-2, 2-4 . . . . The same may apply for the membrane electrode assemblies 18.

The bipolar plates 2 and the multi-layer membrane electrode assembly 18 are aligned to each other by means of several alignment elements 30. FIG. 5 and FIG. 6 show enlarged views of the alignment elements 30 according to the embodiment shown in FIG. 3 (FIG. 5), wherein in FIG. 6 an enlarged view of an alignment element 30 according the second embodiment of FIG. 4 is illustrated.

Due to the voltage potential difference between the bipolar plates 2, the alignment element 30 is made of an electrically isolating material, for example a plastic material, which is molded, preferably injection molded. In a special embodiment, which is not illustrated, the alignment element 30 may also be an integral part of the multi-layer membrane electrode assembly 18, preferably of the subgasket 28.

As can be seen in FIGS. 5 and 6, the alignment element 30 has a base plate 32 and a adjusting portion 34, wherein the adjusting portion 34 is recessed from the base plate 32 so that a step 33 is formed between the base plate 32 and the adjusting portion 34. Thus, the base plate 34 has a height h_{b} and the adjusting portion has an overall height hₐ.

The adjusting portion 34 in turn comprises a first adjusting part 36 and a second adjusting part 38, wherein the second adjusting part 38 is recessed to the first adjusting part 38, thereby forming a further step 37 between the first and the second adjusting part 36, 38 of the adjusting portion 34. Thereby the first adjusting part 36 has a height hₐ₁ and the second adjusting part 38 has a height hₐ₂.

Opposite to the adjusting portion 34, the base plate 32 of the alignment element 30 has a recess 39. A size and depth hᵣ of the recess 39 is chosen such that the adjusting portion 34, and particularly the adjusting part 38, of an adjacent alignment element 30 can be accommodated in the recess 39, so such that the alignment elements 30 can be stacked onto each other. This will be described in detail further below.

Referring again to FIGS. 3 and 4, a height of the base plate 32 is preferably designed to resemble a thickness D_{PS} of the protruding structure 10, e.g. a bead seal, of the bipolar plate 2: h_{b}˜D_{PS}, preferably h_{b}≤D_{PS}. This allows for an arrangement of the inner alignment element 30 at the bipolar plate 3 without any further space requirement for the alignment element 30. Preferably, the size or the height of the base plate is designed so that even after compression of the stack the height h_{b} of the base plate 32 is still less than the height of the protruding structure 10. Thereby it should be noted that all heights relation as described in this application may also apply after compression of the stack.

As can also be seen in FIGS. 3, 4, the overall height of the alignment element H is designed to be at least equal to or greater than two cell pitches d=D_{MEA}+D_{BPP}, wherein one cell pitch is defined as the distance between two unit fuel cells, wherein each unit fuel cell consists of a bipolar plate 2 and a membrane electrode assembly 18: H≥2*(D_{MEA}+D_{BPP}).

In the illustrated embodiments of FIGS. 3 and 5, and FIGS. 4 and 6, respectively, the heights hₐ₁, hₐ₂ of the adjusting potion 34 are differently designed. In the embodiment as illustrated in FIG. 5 and FIG. 3, the height hₐ₁ of the first adjusting part 36 resembles one cell pitch (hₐ₁˜D_{BPP}+D_{MEA}), whereas the height hₐ₂ of the second adjusting part 38 is greater than one cell pitch: (h_{b2}≥D_{BPP}+D_{MEA}). In this embodiment, it is preferred that also the membrane electrode assembly 18 is equipped with first and second alignment through holes 20, 22, which differ in size and shape.

In the other preferred embodiment, which is shown in FIG. 6 and FIG. 4, the height hₐ₁ of the first adjusting part 36 is less than the height of the protruding structure (hₐ₁≤D_{PS}), whereas the height hₐ₂ of the second adjusting part 38 is greater than the one cell pitch plus the heights of a membrane electrode assembly: (hₐ₂≥D_{BPP}+2*D_{MEA}). This allows for a fuel cell stack 1, wherein only the bipolar plates 2 need to be equipped with first and second alignment through holes 14, 16. The membrane electrode assembly 18 may be provided with equal sized alignment through holes 20, 22.

As can be seen in FIGS. 3 and 4, the size of the first adjusting part 36 may resemble the size of the first alignment through hole 14 of the bipolar plate 2 and the size of the second adjusting part 38 may resemble the size of the second alignment through hole 16 of the bipolar plate 2. For the membrane electrode assembly 18, the situation is different as for example in FIG. 3, likewise the bipolar plate 2, the size of the first adjusting part 36 may resemble the size of the first alignment through hole 20 of the membrane electrode assembly 18 and the size of the second adjusting part 38 may resemble the size of the second alignment through hole 22 of the membrane electrode assembly 18. In the embodiment of FIG. 4, in contrast, the sizes of both alignment through holes 20 and 22 of the membrane electrode assembly 18 may both resemble the size of the second adjusting portion 38.

Further with reference to FIGS. 3 and 4, the alignment elements are alternatingly arranged at the bipolar plates 2. That means, at bipolar plate 2-1, a first alignment element 30-1 is arranged at the first alignment through hole 14-1 of the first bipolar plate 2-1, so that the base plate 32 contacts the first bipolar plate 2-1 and the first adjusting portion 36-1 of the first alignment element 30-1 extends through the first alignment hole 14-1. In the second alignment through hole 16-1 of the first bipolar plate 2-1 in turn, a second alignment element 30-2 is arranged in such a way that its second adjusting portion 38-2 extends through the second alignment through hole 16-1 of the first bipolar plate 2-1.

At the adjacent bipolar plate 2-2, the situation is the same, but the alignment through holes 14-2, 16-2 are vice versa, as the bipolar plate 2-2 is rotated by 180°. Thus, the second adjusting portion 38-1 of the first alignment element 30-1 extends through the corresponding second alignment through hole 16-2 of the second bipolar plate 2-2, whereas at the first alignment through hole 14-2 of the second bipolar plate 2-2, the base plate 32-3 of a third alignment element 30-3 is arranged, and its first adjusting portion 36-3 extends through the first alignment through hole 14-2 of the second bipolar plate 2-2.

For the third bipolar plate 2-3 or in general for the n+1 bipolar plate in the stack, the situation is the same as for the first bipolar plate and for the fourth bipolar plate 2-4 or in general the 2n bipolar plate the situation is the same as for the second bipolar plate 2-2.

As mentioned above and illustrated in the enlarged views of FIGS. 3a and 4a, the overall height ha of the adjusting portion 34 of the alignment element 30 is adapted to be greater than two cell pitches d. In other words, the adjusting portion 34-1 of the first alignment element 30 extends through the second alignment through hole 16-2 of the second bipolar plate 2-2 and the second membrane electrode assembly 18-2 and protrudes over the second membrane electrode assembly 18-2 and into the space provided by the protruding structure 10-3 of the third bipolar plate 23. This design allows for a stacking of the alignment elements 30-1 and 30-3, as the part of the adjusting part 38 which extends into the space of the third bipolar plate can be accommodated in the recess 39-2 of the adjacent alignment element 30-2.

For that, the recess 39 of a first alignment element 30-1 and the second adjusting part 38-1 of the first alignment element 30-1, are preferably designed so that the second adjusting part 38 of the second alignment element 30-2 can be accommodated in the recess 29 of the first alignment element 30-1. Thus, a depth hᵣ of the recess 39 is designed so that the part of the adjusting part 38 which extends into the space of the third bipolar plate is adapted to the depth hᵣ of the recess.

For compensating for the height reductions, when the stack is compressed after stacking, the alignment through holes and the alignment elements may be designed so that during stacking only a loose fit is provided between the aligning parts 36, 38 and the corresponding alignment through holes 14, 16. When the stack is compressed, the alignment elements may be deformed for filling out the remaining space. Alternatively or additionally, the recess 39 of the base plate 22 may be made deeper than necessary for accommodating the additional height of the alignment element during the compression.

In summary by providing alignment through holes that cooperate with respective alignment elements it is possible to provide a fuel cell stack which allows for a more efficient stacking and a more reliable alignment of the stack components without the risk of loosing the alignment when the stack is removed from the alignment feature. Simultaneously, the cooperating alignment through holes and alignment elements allow balancing of manufacturing tolerance in the thickness of the plates.

### REFERENCE NUMERALS

1 Fuel cell stack

2 Bipolar plate

4, 6 reactant/coolant manifold

8 Flow field part

10 protruding element

12 basis of the bipolar plate

14 first alignment through hole (bipolar plate)

16 Second alignment through hole (bipolar plate)

18 Membrane electrode assembly

20 First alignment through hole (membrane electrode assembly)

22 Second alignment through hole (membrane electrode assembly)

24 active region

26 manifold openings

28 subgasket

30 Alignment element

32 Base plate

34 adjusting portion

33 Step between base plate and adjusting portion

36 first adjusting part

38 second adjusting part

37 step between first and second adjusting part

39 Recess

H Overall height of the alignment element

h_{b} Height of the base plate

hₐ Height of the adjusting portion

hₐ₁ Height of the first adjusting part

hₐ₂ Height of the second adjusting part

D_{MEA} Thickness of the membrane electrode assembly

D_{BPP} Thickness of the bipolar plate

D_{PS} Thickness of the protruding portion of the bipolar plate d Cell pitch

1-13. (canceled)

14. Electric cell stack comprising at least a plurality of electric plates and a plurality of insulating layers, wherein the stack of the plurality of electric plates and insulating layers are alternatingly stacked in such a way that the electric plates are separated by insulating layers, and the electric plates and/or the insulating layers are aligned to each other,
wherein each electric plate has a first alignment through hole and a second alignment through hole, wherein at and/or in the alignment through holes inner alignment elements are provided for aligning the electric plates and the insulating layers,
wherein each inner alignment element has a base plate and an adjusting portion protruding from the base plate,
wherein the adjusting portion of one alignment element extends through at least a first electric plate, a first insulating layer, a second electric plate and a second insulating layer, so that an overall height H of the alignment element is equal to or greater than two cell pitches H≥2*(D_{EP}+D_{IL}), and
wherein the adjusting portion of each alignment element has a first adjusting part and a second adjusting part, wherein a size and/or shape of the first adjusting part is adapted to the size and/or shape of the first alignment through hole and/or a size and/or shape of the second adjusting part is adao the size and/or shape of the second alignment through hole.

15. Electric cell stack according to claim 14, wherein the first alignment through hole has a first shape, preferably an elongated shape, and the second alignment through hole has a second shape, preferably circular shape, wherein the first and second shape are different.

16. Electric cell stack according to claim 14, wherein the adjusting portion of the alignment element is recessed from the base plate, so that a step is formed between the base plate and the adjusting portion.

17. Electric cell stack according to claim 14, wherein at the opposite side of the adjusting portion, the base plate of the alignment element has a recess which is dimensioned to accommodate the adjusting portion of an adjacent second alignment element, so that one alignment element is adapted to be stacked on a further alignment element.

18. Electric cell stack according to claim 14, wherein the second adjusting part is recessed from the first adjusting part, thereby forming a step between the first and the second adjusting part of the alignment element.

19. Electric cell stack according to claim 14, wherein a height hₐ₁ of the first adjusting part of the adjusting portion is designed to correspond to at least one cell pitch, i.e. the thickness of one electric plate plus one insulating layer, or an integer multiple of cell pitches, hₐ₁=x* (D_{EP}+D_{IL}), with x being an integer, and a height hₐ₂ of the second adjusting part of the adjusting portion is designed to be equal to or greater than at least one cell pitch, or an integer multiple of cell pitches, i.e. the thickness of one electric plate and one insulating layer, hₐ₂≥x*(D_{EP}+D_{IL}), with x being an integer.

20. Electric cell stack according to claim 19, wherein the height hₐ₂ of the second adjusting part of the adjusting portion is designed to be greater than at least one cell pitch, or an integer multiple of cell pitches hₐ₂>x*(D_{EP}+D_{IL}), with x being an integer, so that the second adjusting portion exceeds the height of one cell pitch or of an integer multiple of one cell pitch by an excess portion, and wherein at the opposite side of the adjusting portion, the base plate of the alignment element has a recess which is dimensioned to accommodate the excess portion of the second adjusting part of the adjusting portion of an adjacent second alignment element, so that one alignment element is adapted to be stacked on a further alignment element, wherein a depth of the recess is adapted to accommodate the excess portion of the second adjusting part of the adjusting portion (34), so that hₐ₂˜x*(D_{EP}+D_{IL})+hᵣ.

21. Electric cell stack according to claim 14, wherein the alignment elements are arranged in such a way that for each single electric plate one of the alignment through holes is in contact with the base plate of a first alignment element, wherein the other alignment through hole of the very same electric plate is in contact with the adjusting portion of another second alignment element.

22. Electric cell stack according to claim 15, wherein the base plate of the inner alignment element is arranged at/in the first alignment through hole having the first shape.

23. Electric cell stack according to claim 14, wherein adjacent electric plates and the corresponding first and second alignment through hole are arranged in such a way that the first alignment through hole of one electric plate is aligned with the second alignment through hole of the adjacent electric plate.

24. Electric cell stack according to claim 14, wherein the electric plate has at least one protruding structure which protrudes from a basis of the electric plate in direction to the adjacent insulating layer with a height D_{PS}, and wherein a height h_{b} of the base plate of the alignment element is designed to be equal or less than the height D_{PS} of the protruding structure.

25. Electric cell stack according to claim 14, wherein the alignment element is made of an electrically isolating material, preferably a plastic material; wherein preferably, the alignment element is molded, preferably injection molded.

26. Electric cell stack according to claims 14, wherein the electric cell stack is a fuel cell stack, the electric plate is a bipolar plate (BPP) consisting of an anode plate and a cathode plate which are fixed to each other, and the insulating layer is a multilayer membrane electrode assembly (MEA).
